(19) United States
(12) Patent Application Publication
(10) Pub. No.: US 2016/0336739 A1
(43) Pub. Date: Nov. 17, 2016

(54) INRUSH CURRENT SUPPRESSION CIRCUIT

(71) Applicant: YAZAKI CORPORATION, Tokyo (JP)

(72) Inventors: Yoshinori Matsushita, Shizuoka (JP); Osamu Kimura, Shizuoka (JP)

(21) Appl. No.: 15/208,817

(22) Filed: Jul. 13, 2016

Related U.S. Application Data
(63) Continuation of application No. PCT/JP2015/054346, filed on Feb. 17, 2015.

(30) Foreign Application Priority Data
Feb. 18, 2014 (JP) 2014-028150

(51) Int. Cl. H02H 9/00; H02H 9/02

(52) U.S. Cl. CPC H02H 9/001; H02H 9/025

(57) ABSTRACT

An inrush current suppression circuit suppresses an inrush current to flow through a load including an input capacitor connected to a power source and a pair of output terminals which are parallel-connected to the input capacitor and output an input current. The inrush current suppression circuit includes a switching element connected to the power source; at least one of a first inductor connected between the switching element and a connection point of connecting one of the pair of output terminals and one electrode of the input capacitor and a second inductor connected between an anode of the diode and a connection point of connecting the other electrode of the input capacitor and the other of the pair of output terminals; and a diode whose cathode is connected to a connection point of connecting the switching element and the first inductor.

### CROSS REFERENCE TO RELATED APPLICATIONS

This application is a continuation of PCT application No. PCT/JP2015/054346, which was filed on Feb. 17, 2015 based on Japanese Patent Application (No. 2014-028150) filed on Feb. 18, 2014, the contents of which are incorporated herein by reference.

### BACKGROUND OF THE INVENTION

1. Field of the Invention

The present invention relates to an inrush current suppression circuit.

2. Description of the Related Art

When an apparatus (load) is powered on, there may occur an event that a large current (inrush current) that is larger than a steady-state current flows from a power source to the load. An inrush current may adversely affect various locations of an apparatus, and inrush current suppression circuits for suppressing an inrush current to flow from a power source are known.

JP-A-8-275383 discloses an inrush current suppression circuit that utilizes the principle of a step-down chopper circuit. This inrush current suppression circuit has a DC power source as an input source and outputs power to a load from a pair of output terminals. The inrush current suppression circuit is equipped with a series circuit of an FET and a coil between the positive pole of the DC power source and one of the output terminals. The other output terminal is connected to the ground of the DC power source, and a free wheel diode is anti-parallel-connected to the coil. A capacitor is provided between the one output terminal and the ground of the DC power source.

In this inrush current suppression circuit, a control voltage is output from a drive circuit to the gate of the FET in response to a radio-frequency pulse signal and the FET is switched in response to the control voltage. An input voltage as switched by the FET is applied to the coil, and a current flows through the FET only in on-periods of the FET and the capacitor is thereby charged. In off-periods of the FET, the charging of the capacitor is suspended and a coil current decreases circulating the coil and the diode. As these cycles continue, the capacitor is charged every time a radio-frequency pulse signal occurs. During that course, the peak current of a charging current decreases gradually and reaches zero when the charging of the capacitor is completed.

Incidentally, the technique disclosed in JP-A-8-275383 uses the coil as an inductor. In apparatus using large currents, large-diameter wires are used and it is necessary to form the coil by winding such a large-diameter wire, which raises a problem that the circuit is increased in size. Furthermore, in the case of using a large-diameter wire, coil winding work takes time and labor, resulting in another problem that manufacturing work is complicated.

### SUMMARY OF THE INVENTION

The present invention has been made in view of the above circumstances, and an object of the invention is therefore to provide an inrush current suppression circuit capable of preventing increase of the circuit size and simplifying manufacturing work.

To solve the above problems, the invention provides an inrush current suppression circuit that suppresses an inrush current supplied from a power source to flow through a load. The inrush current suppression circuit suppresses an inrush current to flow through the load including an input capacitor connected to the power source and a pair of output terminals which are parallel-connected to the input capacitor and output an input current supplied from the power source. The inrush current suppression circuit comprises a switching element connected to the power source and on/off-controlled; a first inductor connected between the switching element and a connection point of connecting one of the pair output terminals and one electrode of the input capacitor; a diode whose cathode is connected to a connection point of connecting the switching element and the first inductor; and a second inductor connected between an anode of the diode and a connection point of connecting the other electrode of the input capacitor and the other of the pair of output terminals. In this configuration, each of the first inductor and the second inductor includes a magnetic member which covers a circumferential surface of an electric wire serving as a current path.

In the above configuration, it is preferable that the magnetic member is formed by plural divisional ring-shaped elements arranged in an axial direction and a prescribed length of the magnetic member is changeable by selecting the number of ring-shaped elements.

Since each inductor includes the magnetic member, the invention can prevent increase of the circuit size and simplify manufacturing work.

### BRIEF DESCRIPTION OF THE DRAWINGS

FIG. 1 is a circuit diagram showing the configuration of an inrush current suppression circuit conceptually.

FIG. 2 is an explanatory diagram showing the structure of each of first and second inductors schematically.

FIGS. 3A and 3B are explanatory diagrams schematically showing the principle of operation of the inrush current suppression circuit; FIGS. 3A and 3B show states that the FET 5 is on and off, respectively.

FIGS. 4A and 4B are explanatory diagrams showing current waveforms and voltage forms at individual elements; FIG. 4A shows a current non-continuous mode in which the inductor current is not continuous, and FIG. 4B shows a current continuous mode in which the inductor current is continuous.

FIGS. 5A and 5B are explanatory diagrams showing results of an experiment that was carried out using the inrush current suppression circuit; FIG. 5A is an explanatory diagram showing a variation of an inductor current IL, and FIG. 5B is an explanatory diagram showing a variation of a voltage Vcon across an input capacitor 10.

### DETAILED DESCRIPTION OF THE EXEMPLARY EMBODIMENTS

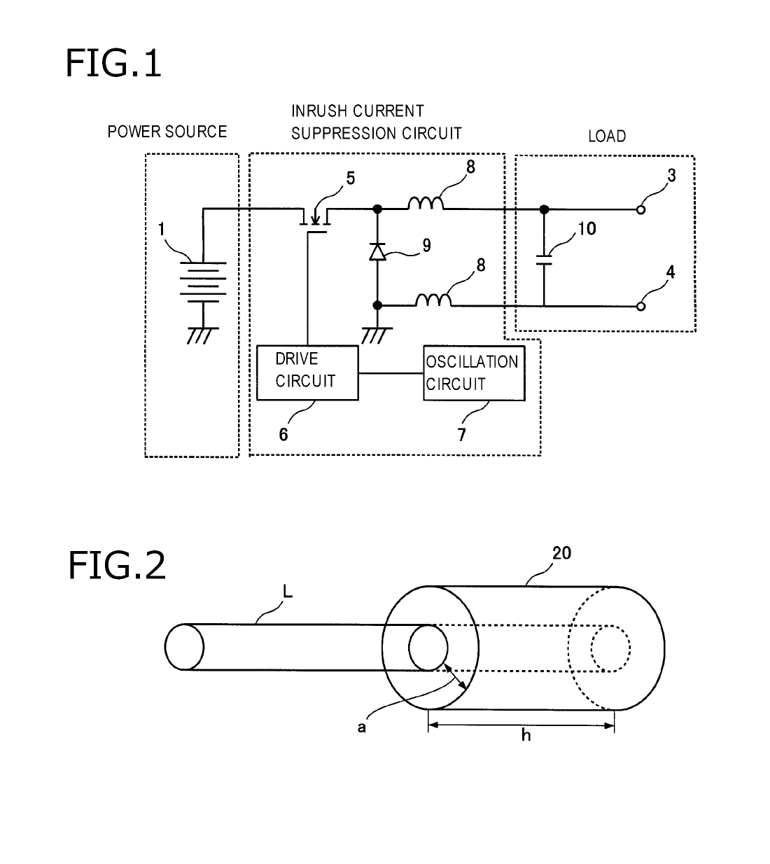

FIG. 1 is a circuit diagram showing the configuration of an inrush current suppression circuit according to an embodiment. The inrush current suppression circuit according to the embodiment serves to output power to a load receiving an input from a DC power source 1 and suppresses an inrush current to flow from the DC power source 1 (e.g., battery) to the load. The inrush current suppression circuit mainly includes an FET 5, first and second inductors 8, and a free wheel diode 9.

The load includes an input capacitor 10 and a pair of output terminals 3 and 4 and is an inverter, for example.

The input capacitor 10 is connected to the DC power source 1 via the inrush current suppression circuit and is disposed on the input side of the pair of output terminals 3 and 4.

The pair of output terminals 3 and 4 are parallel-connected to the input capacitor 10 and outputs an input current supplied from the DC power source 1. A load element (not shown) is connected between the output terminals 3 and 4. The output terminals 3 and 4 correspond to the positive pole side and the ground side of the DC power source 1, respectively.

The FET 5 is a switching element that is connected to the DC power source 1 and on/off-controlled. More specifically, the drain of the FET 5 is connected to the positive pole side of the DC power source 1 and its source is connected to the one output terminal 3 via the first inductor 8. The gate of the FET 5 is connected to a drive circuit 6. The FET 5 is turned on when an on-control signal is input to its gate, and is turned off when an off-control signal is input to its gate. It is possible to use a switching element other than an FET (Field-Effect Transistor).

The drive circuit 6 outputs an on/off control signal on the basis of a radio-frequency pulse signal supplied from an oscillation circuit 7 (described later), and applies a prescribed control voltage to the gate of the FET 5. The oscillation circuit 7 serves to output-control the drive circuit 6 and outputs the radio-frequency pulse signal to the drive circuit 6. A switching frequency and a duty ratio of the FET 5 can be set through the drive circuit 6 and the oscillation circuit 7.

The first inductor 8 is provided on the side of the positive pole of the DC power source 1. More specifically, the first inductor 8 includes an electric wire that is connected between the connection point of the one output terminal 3 and the one electrode of the input capacitor 10 and the source of the FET 5 and a magnetic member that covers at least part of the electric wire. The second inductor 8, which is provided on the side of the ground of the DC power source 1, includes an electric wire that is connected between the connection point of the other electrode of the input capacitor 10 and the other output terminal 4 and the anode of the free wheel diode 9 and a magnetic member that covers at least part of the electric wire. The inductance values of the first and second inductors 8 are set identical.

The cathode of the free wheel diode 9 is connected to the connection point of the FET 5 and the first inductor 8. The anode of the free wheel diode 9 is connected to the side, opposite to the connection point of the other electrode of the input capacitor 10 and the other output terminal 4, of the second inductor 8.

FIG. 2 is an explanatory diagram showing the structure of each of the first and second inductors 8 schematically. In the embodiment, each of the above-mentioned first and second inductors 8 (hereinafter referred to generically as an “inductor 8”) includes a magnetic member 20. The magnetic member 20 is a ring-shaped member having a prescribed length in the axial direction and is a magnetic member produced by shaping a magnetic material. The radial length (i.e., the length from the inside surface that is in contact with an electric wire L to the outside surface) and the axial length of the ring-shaped magnetic member 20 are represented by a and h, respectively. The electric wire L as a current path is inserted through the inside space of the magnetic member 20, and hence the magnetic member 20 covers the circumferential surface of the electric wire L.

The magnetic material of the magnetic member 20 is selected depending on a current to flow through the electric wire L. For example, to cause a flow of a large current up to about 300 A, it is preferable to select a magnetic material having a high saturated magnetic flux density such as permendur or electromagnetic soft iron.

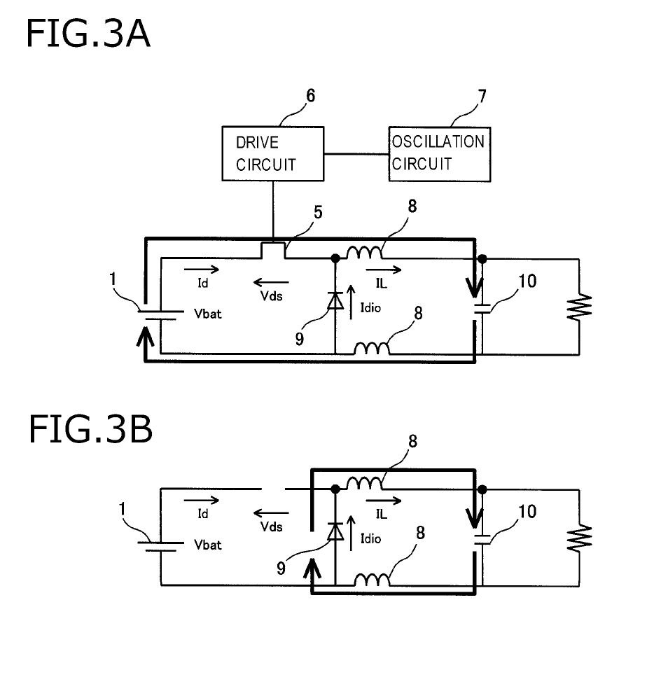

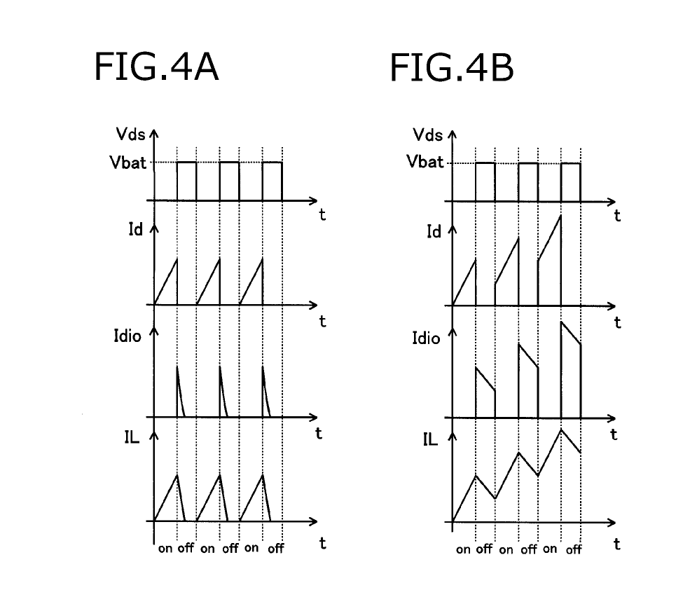

FIGS. 3A and 3B are explanatory diagrams schematically showing the principle of operation of the inrush current suppression circuit according to the embodiment; FIGS. 3A and 3B show states that the FET 5 is on and off, respectively. FIGS. 4A and 4B are explanatory diagrams showing current waveforms and voltage forms at individual locations; FIG. 4A shows a current non-continuous mode in which the inductor current is not continuous, and FIG. 4B shows a current continuous mode in which the inductor current is continuous.

While the FET 5 is on, a voltage (assumed to be 0 V in FIGS. 4A and 4B) that is equal to a voltage drop of the on resistance of the FET 5 develops between the drain and the source of the FET 5. In FIGS. 4A and 4B, Vds represents the drain-source voltage. On the other hand, while the FET 5 is off, a power source voltage Vbat is applied between the drain and the source of the FET 5.

When the FET 5 is turned on, a large drain current Id is to flow to charge the input capacitor 10. However, because of counter electromotive voltages across the inductors 8, as shown in FIGS. 4A and 4B the drain current Id increases with a certain gradient, which depends on the inductance value of the inductors 8. Current peak values can be controlled using the on time and the inductance value. The drain current Id stops flowing as soon as the FET 5 is turned off.

The diode current Idio does not flow while the FET 5 is on. On the other hand, when the FET 5 is turned off, the current is to continue to flow through the inductors 8 and hence there occurs a current flowing along a path shown in FIG. 3B. However, since no current is supplied from the DC power source 1, this current decreases gradually with a certain gradient, which depends on the inductance value of the inductors 8. By changing this gradient or the off time, the operation mode can be switched to the current continuous mode (FIG. 4A) or the current non-continuous mode (FIG. 4B).

While the FET 5 is on, a drain current Id flows as an inductor current IL. On the other hand, while the FET 5 is off, a diode current Idio flows as an inductor current IL. In the current non-continuous mode, the peak value decreases gradually as the charging of the input capacitor 10 progresses. On the other hand, in the current continuous mode, as the charging of the input capacitor 10 progresses, the peak value increases until a certain time point and then decreases. After the charging of the input capacitor 10 has completed, the peak value is kept constant. FIGS. 4A and 4B show initial operations in which a measure against an inrush current is taken and hence does not indicate all of the above-described characteristics.

An inrush current can be suppressed by repeating cycles in the above-described manner until charging of the input capacitor 10 is completed. At the time of designing, the above-mentioned parameters can be determined according to such conditions as the operation frequency, duty ratio, inductance value, switching element (maximum rating), diode (maximum rating), and precharging time.

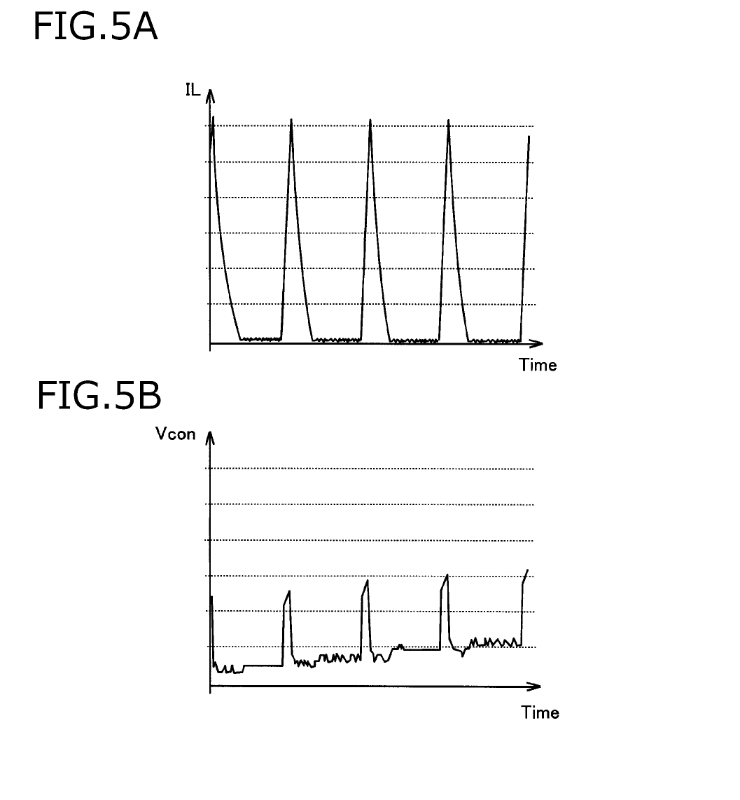

FIGS. 5A and 5B are explanatory diagrams showing results of an experiment that was carried out using an inrush current suppression circuit in which the prescribed parameters were set. FIG. 5A is an explanatory diagram showing a variation of an inductor current IL, and FIG. 5B is an explanatory diagram showing a variation of a voltage Vcon across the input capacitor 10. FIGS. 5A and 5B show a case that an inrush current (inductor current IL) is suppressed in the current non-continuous mode. Voltages of about 12 to 15 V that develop across the input capacitor 10 when the FET 5 is on are due to an equivalent series resistance of the capacitor 10.

As above described above, in the embodiment, the inrush current suppression circuit serves to suppress an inrush current to flow through the load having the input capacitor 10 connected to the power source 1 and the pair of output terminals 3 and 4 which are parallel-connected to the input capacitor 10 and output an input current supplied from the power source 1. The inrush current suppression circuit is equipped with the FET 5 which is connected to the DC power source 1 and on/off-controlled, the first inductor 8 which is connected between a connection point (the connection point of the one output terminal 3 and the one electrode of the input capacitor 10) and the FET 5, the free wheel diode 9 whose cathode is connected to the connection point of the FET 5 and the first inductor 8, and the second inductor 8 which is connected between a connection point (the connection point of the other electrode of the input capacitor 10 and the other output terminal 4) and the anode of the diode 9. In this configuration, each of the first and second inductors 8 includes the magnetic member 20 which covers the circumferential surface of the electric wire L serving as a current path.

Now, assume a case that the inrush current suppression circuit is not equipped with the inductors 8 and the FET 5 is switched from off to on. When the voltage of the DC power source 1 is applied to the inrush current suppression circuit, a large current flows in a short time to charge the input capacitor 10. A problem arises that the FET 5 may be destroyed by this current (inrush current) and become incapable of performing a shutoff operation.

In contrast, in the embodiment, the inductors 8 can prevent a flow of a large current, which solves the problem that the FET 5 is destroyed to become incapable of performing a shutoff operation.

In the embodiment, since the magnetic member 20 is used to form each inductor 8, it is not necessary to form each inductor 8 by winding an electric wire into a coil. This makes it possible to prevent increase of the circuit size that is caused by forming coils by winding a large-diameter electric wire. Since work of winding an electric wire is omitted, advantages can be obtained that manufacturing work is simplified, a manufacturing process is shortened, and cost reduction is attained.

Furthermore, since the inductors 8 having the same inductance value are provided on the positive pole side and the ground side, respectively, the degree of circuit imbalance is lowered and hence a change from common mode noise to normal mode noise can be prevented. Thus, adverse effects on operation that would otherwise occur can be reduced.

Where the magnetic member 20 is used as part of each inductor 8, there are many factors that should be taken into consideration such as the BH curve, frequency characteristic, and dimensions (a, h) of the magnetic member 20, the current to flow through the electric wire, and the operation frequency. Furthermore, because of various factors such as that the current value is not constant and the magnetic member 20 has a width, in designing it is difficult to set a uniform magnetic field in the magnetic member 20. It is therefore preferable to make the axial length h variable by dividing the magnetic member 20 into round slices in the axial direction and set the number of divisional ring-shaped elements at a proper number. This makes it possible to change the axial length h easily at the time of manufacture and thereby absorb design errors.

Although the inrush current suppression circuit according to the embodiment has been described above, the invention is not limited to the embodiment and various modifications are possible without departing from the scope of the invention. For example, the “power source” may be not only one that outputs a DC current as it is like primary batteries and secondary batteries do but also one that outputs a DC current by rectifying an output of an AC power source with a rectifier or even an AC power source itself. Furthermore, although in the embodiment the inductance values of the first and second inductors are set identical, they need not coincide with each other strictly and may be different from each other as long as the inductors exercise equivalent functions.

The features of the above-described inrush current suppression circuit according to the embodiment of the invention will be summarized below in the form of items [1] and [2]:

[1] An inrush current suppression circuit that suppresses an inrush current to flow through a load including an input capacitor (10) connected to a power source (1) and a pair of output terminals (3, 4) which are parallel-connected to the input capacitor and output an input current supplied from the power source, the inrush current suppression circuit comprising:

a switching element (FET 5) connected to the power source and on/off-controlled;

at least one of a first inductor (8) connected between the switching element and a first connection point of connecting one of the pair of output terminals and one electrode of the input capacitor and a second inductor (8) connected between the switching element and a second connection point of connecting the other electrode of the input capacitor and the other of the pair of output terminals; and;

a diode (9) provided between the switching element and the first connection point or the second connection point,

wherein when the switching element is turned on, the inrush current flowing into the input capacitor of the load including is suppressed by the at least one of the first inductor and the second inductor; and

wherein when the switching element is turned off, the input capacitor is charged through the diode by energy accumulated in the at least one of the first inductor and the second inductor.

[2] The inrush current suppression circuit according to item [1], wherein at least one of the first inductor and the second inductor includes a magnetic member which covers a circumferential surface of an electric wire serving as a current path; and

wherein the magnetic member is formed by plural divisional ring-shaped elements arranged in an axial direction and the length of the magnetic member in the axial direction is changeable by selecting the number of ring-shaped elements.

[3] The inrush current suppression circuit according to item [1], comprising:

both of the first inductor and the second inductor.

Although the invention has been described in detail by referring to the particular embodiment, it is apparent to those skilled in the art that various changes and modifications are possible without departing from the spirit and scope of the invention.

Since each inductor includes the magnetic member, the invention can prevent increase of the circuit size and simplify manufacturing work. Providing these advantages, the invention is useful when applied to inrush current suppression circuits.

1. An inrush current suppression circuit that suppresses an inrush current to flow through a load including an input capacitor connected to a power source and a pair of output terminals which are parallel-connected to the input capacitor and output an input current supplied from the power source, the inrush current suppression circuit comprising:
a switching element connected to the power source and on/off-controlled;
at least one of a first inductor connected between the switching element and a first connection point of connecting one of the pair of output terminals and one electrode of the input capacitor and a second inductor connected between the switching element and a second connection point of connecting the other electrode of the input capacitor and the other of the pair of output terminals; and
a diode provided between the switching element and the first connection point or the second connection point,
wherein when the switching element is turned on, the inrush current flowing into the input capacitor of the load including is suppressed by the at least one of the first inductor and the second inductor; and
wherein when the switching element is turned off, the input capacitor is charged through the diode by energy accumulated in the at least one of the first inductor and the second inductor.

2. The inrush current suppression circuit according to claim 1, wherein at least one of the first inductor and the second inductor includes a magnetic member which covers a circumferential surface of an electric wire serving as a current path; and
wherein the magnetic member is formed by plural divisional ring-shaped elements arranged in an axial direction and length of the magnetic member in the axial direction is changeable by selecting the number of the ring-shaped elements.

3. The inrush current suppression circuit according to claim 1, comprising:
both of the first inductor and the second inductor.
